(19) United States
(12) Patent Application Publication
(10) Pub. No.: US 2003/0103886 A1
(43) Pub. Date: Jun. 5, 2003

(54) NOx adsorber catalyst configurations and method for reducing emissions

(76) Inventor: Danan Dou, Tulsa, OK (US)

Correspondence Address: Vincent A. Cichosz, DELPHI TECHNOLOGIES, INC., 4th Floor, 1450 West Long Lake, Troy, MI, 48098, US

(21) Appl. No.: 10/006,499

(22) Filed: Dec. 3, 2001

(51) Int. Cl. B01J 23/46; B01D 53/56

(52) U.S. Cl. 423/239.1; 502/325

(57) ABSTRACT

Disclosed herein is a catalyst configuration, a NOx adsorber comprising the catalyst configuration, and a method for reducing emissions. The catalyst configuration comprises: a substrate, an underlayer disposed on the substrate, the underlayer comprising a first catalyst composition, and an overlayer disposed on a side of the underlayer opposite the substrate. The overlayer comprises a second catalyst composition comprising greater than or equal to about 75% of Rh in the catalyst configuration.

### BACKGROUND OF THE INVENTION

In order to meet government mandated exhaust gas emission standards, the exhaust gases of an automotive internal combustion engine must be treated before emission into the atmosphere. Exhaust gases are routed through a catalytic converter device. The exhaust gases generally contain undesirable emission components including carbon monoxide (CO), hydrocarbons (HC), and nitrogen oxides (NO_{X}). As a means of simultaneously removing the objectionable CO, HC, and NO_{X} components, various “three-way” catalysts have been developed. Such catalysts can employ one or more noble metals such as platinum (Pt), and palladium (Pd), disposed on an alumina support. As such, the undesirable components can then be converted to less harmful or non-harmful ones.

Direct injection gasoline (GDI) engines and diesel engines offer improved fuel economy and reduced CO₂ emission. The exhaust from GDI and diesel engines contains excess amount of O₂. Although the oxidation of HC and CO are highly efficient with excess O₂, the removal of NO_{X} components is of particular concern, and can be accomplished using a NO_{X} adsorber. The efficiency of the NOx adsorber is determined by three parameters of the adsorber catalyst (a) NO_{X} storage efficiency and capacity, (b) effective NO_{X} release under rich operating conditions, and (c) effective NO_{X} conversions. A lack of conversion efficiency will result in higher NOx emissions. Consequently, advances in NOx adsorbers and adsorber catalysts are continually sought. NOx adsorber catalysts with improved NOx storage capacity and improved NOx conversion efficiency are desirable.

### SUMMARY OF THE INVENTION

Disclosed herein is a catalyst configuration, a NOx adsorber comprising the catalyst configuration, and a method for reducing emissions. The catalyst configuration comprises: a substrate, an underlayer disposed on the substrate, the underlayer comprising a first catalyst composition, and an overlayer disposed on a side of the underlayer opposite the substrate. The overlayer comprises a second catalyst composition comprising greater than or equal to about 75% of Rh in the catalyst configuration.

The above described and other features are exemplified by the following figures and detailed description.

### BRIEF DESCRIPTION OF THE DRAWINGS

Referring now to the figures wherein the like elements are numbered alike: FIG. 1 shows a catalyst configure wherein Rh is present uniform in both washcoat layers.

FIG. 2 shows a catalyst configuration wherein Rh is present predominately in the overlayer.

FIG. 3 shows a catalyst configuration wherein Rh is present predominately in the outer layer of the overlayer.

FIG. 4 is a graph comparing catalyst configuration based on NO_{X} conversion over evaluation temperatures under the condition of lean/rich modulations after aging of the catalyst.

FIG. 5 is a graph comparing catalyst configuration based on HC conversion over evaluation temperatures under the condition of lean/rich modulations after aging of the catalyst.

FIG. 6 is a graph showing stoichiometric light off temperatures after aging of the catalyst.

FIG. 7 is graph showing microprobe data showing that the Rh catalyst-containing outer layer of the overlayer is 10 micrometers thick

### DESCRIPTION OF PREFERRED EMBODIMENT

A catalyst configuration, comprising a substrate, an underlayer disposed on the substrate, the underlayer comprising less than or equal to about 5 weight percent Rh catalyst, and an overlayer disposed on a side of the underlayer opposite the substrate. The overlayer preferably comprises greater than or equal to about 75% of the rhodium (Rh) catalyst in the catalyst configuration. It is further preferred that greater than or equal to about 75% of the Rh catalyst in the catalyst configuration be disposed in an outer portion of the overlayer. Additionally, the catalyst configuration may comprise a trapping material and/or a noble metal catalyst

The substrate can comprise any material designed for use in a spark ignition or diesel engine environment, and have the following characteristics: (1) capable of operating at temperatures up to about 1,000° C.; (2) capable of withstanding exposure to hydrocarbons, nitrogen oxides, carbon monoxide, carbon dioxide, sulfur and/or sulfur oxides; and (3) having sufficient surface area and structural integrity to support the desired catalyst. Some possible materials include cordierite, silicon carbide, metallic foils, alumina sponges, porous glasses, and the like, and mixtures comprising at least one of the foregoing materials, with cordierite preferred. Some ceramic materials include “HONEY CERAM”, commercially available from NGK-Locke, Inc, Southfield, Mich., and “CELCOR”, commercially available from Coming, Inc., Corning, N.Y.

Although the catalyst substrate can have any size or geometry, the size and geometry are preferably chosen to optimize surface area in the given catalytic converter design parameters. Typically, the catalyst substrate has a honeycomb geometry, with the combs being any multi-sided or rounded shape, with substantially square, triangular, hexagonal, or similar geometries preferred due to ease of manufacturing and increased surface area.

The underlayer, which is disposed on (i.e., in physical contact with the substrate) by wash coating, imbibing, impregnating, physisorbing, chemisorbing, spraying, dipping, coating, precipitating, or otherwise applying it to the substrate, comprises a catalyst and optionally trapping materials. The catalyst can comprise a material such as platinum, palladium, rhodium, iridium, osmium, ruthenium, tantalum, zirconium, yttrium, cerium, aluminum, nickel copper, and the like, as well as oxides, alloys, cermets, and combinations comprising at least one of the foregoing metals. A preferred catalyst comprises platinum (Pt) since it functions to oxidize NO to generate NO₂, and palladium (Pd) to enhance light-off and low temperature NOx conversions. In one embodiment, the catalyst can comprise about 10 grams per cubic foot (g/ft³) to about 200 g/ft³ of platinum, less than or equal to about 200 g/ft³ of palladium, and less than or equal to about 30 g/ft³ of rhodium, with about 30 g/ft³ to about 100 g/ft³ platinum, about 5 g/ft³ to about 60 g/ft³ palladium, and about 2 g/ft³ to about 15 g/ft³ rhodium preferred. For optimum efficiency, the catalyst materials are preferably uniformly distributed throughout the underlayer.

The underlayer and overcoat may further comprise trapping materials. The trapping materials can comprise any material effective in the storage of nitrogen oxides, and especially nitrogen dioxide (NO₂). For example, the trapping materials react with the NO₂ oxidized from NO by the catalyst to form, for example, Ba(NO₃)₂ and KNO₃. The reaction of the oxidation product with the trapping materials can occur as shown in Equations 1-3.

Pt

NO+0.5O₂→NO₂ (1)

2NO₂+0.5O₂+BaCO₃→Ba(NO₃)₂+CO₂ (2)

2NO₂+0.5O₂+K₂CO₃→2KNO₃+CO₂ (3)

To maximize the NOx storage capacity, it is useful to have the trapping materials located in close proximity to the catalyst. Therefore, it is preferred that the trapping materials also be uniformly distributed throughout the underlayer. Possible trapping materials comprise rare earths, alkaline earths, and the like, as well as oxides, carbonates, alloys, and combinations comprising at least one of the foregoing trapping materials. Examples of these materials include barium (Ba), strontium (Sr), potassium (K), cesium (Cs), sodium (Na), lithium (Li), and the like, as well as alloys, oxides, carbonates, and combinations comprising at least one of the foregoing materials.

Disposed on a side of the underlayer opposite the substrate is an overlayer. As with the underlayer, the overlayer may be wash coated, imbibed, impregnated, physisorbed, chemisorbed, sprayed, dipped, coated, precipitated, or otherwise applied to the underlayer, and it comprises catalyst and optionally trapping materials. The inner portion of the overlayer disposed adjacent to the underlayer comprises the same materials as discussed in the underlayer, and may optionally comprise the same composition as the underlayer. However, the overlayer, which comprises two portions, an inner portion disposed in physical contact with the underlayer, and an outer portion disposed on a side of the inner portion opposite the underlayer, comprises a different composition in the outer portion. The outer portion can be several micrometers thick. Preferably, the outer portion has a thickness of about 1 to about 30 micrometers, with a thickness of about 5 to about 15 micrometers preferred, and a thickness of about 7 to about 12 micrometers more preferred.

In addition to optionally comprising catalyst and trapping materials such as those discussed above, the outer portion further comprises rhodium (Rh), typically in an amount of about 2 g/ft³ to about 30 g/ft³. The Rh, which is effective in the conversion of pollutants to carbon dioxide (CO₂), water (H₂O), and nitrogen (N₂), can preferably be present, within the range, of less than or equal to about 20 g/ft³ preferred, with less than or equal to about 15 g/ft³ more preferred. Also preferred, within this range, is an amount of Rh of greater than or equal to about 5 g/ft³, with greater than or equal to about 7 g/ft³ even more preferred.

The desired washcoat loading (i.e., coating loading) on the substrate is based upon the type of substrate and, in particular, the cell density of the substrate and the flow restrictions that can be caused by the loading. Generally a catalyst loading of greater than or equal to about 1 grams per cubic inch (g/in³) (about 16.4 grams per cubic centimeter (g/cc)) can be employed, with greater than or equal to about 2 g/in³ (about 32.8 g/cc) preferred, and greater than or equal to about 3 g/in³ (about 49.2 g/cc) especially preferred. It is further preferred to employ a washcoat loading of less than or equal to about 10 g/in³ (about 164 g/cc), with less than or equal to about 7 g/in³ (about 114.8 g/cc) more preferred, and less than or equal to about 5 g/in³ (about 82 g/cc) especially preferred

In order to efficiently and effectively employ the various components of the catalyst configuration, the underlayer preferably comprises a minimum amount of Rh. Rh is effective in converting NO_{X} and HC to CO₂, H₂O, and N₂ under rich conditions (e.g., fuel rich) where carbon monoxide (CO) is the predominant reductant available. Consequently, Rh is preferably located in the overlayer, and more preferably in the outer portion thereof. Disposal of the Rh in the underlayer is not efficient in enabling its reaction with the CO. Prior to the use of the catalyst configuration, it is especially preferred to comprise immeasurable amounts of Rh in the underlayer (based upon current equipment capabilities). Essentially, it is preferred not to add Rh to the underlayer. However, it is understood that, although Rh is not added to the underlayer, it may be present as a contaminant and/or some Rh may migrate from the overlayer into the underlayer.

To facilitate the desired emissions reduction, greater than or equal to about 75 weight percent (wt %) of the Rh in the catalyst configuration is preferably disposed in the outer portion, with greater than or equal to 80 wt % more preferred, greater than or equal to 85 wt % even more preferred, and greater than or equal to 90 wt % especially preferred. It is further preferred that greater than or equal to about 95 wt % of the Rh in the catalyst configuration be in the overlayer with greater than or equal to 95 wt % more preferred, greater than or equal to 99 wt % even more preferred, greater than or equal to 99.5 wt % yet more preferred, and greater than or equal to 99.9 wt % especially preferred.

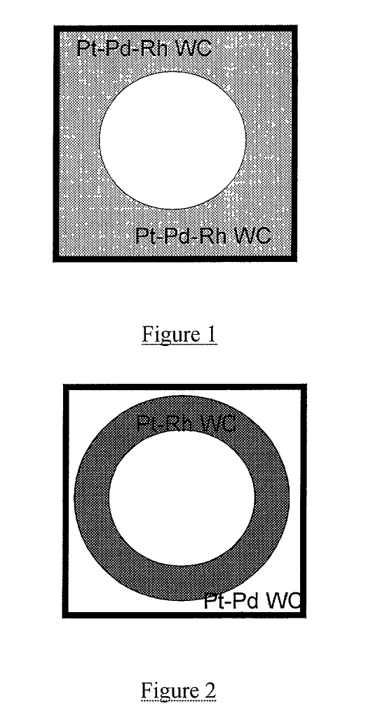

An example composition comprises an undercoat with 1.3 grams per cubic inch (g/in³) of gamma alumina (γ-Al₂O₃) and 0.13 g/in³ alumina (Al₂O₃) binder, 0.35 g/in³ of ceria (CeO₂) or stabilized CeO₂ (mixed oxide of zirconia-ceria (ZrO₂—CeO₂)); an overcoat with the same composition as the underlayer; with a total washcoat loading of 3.61 g/in³. The precious metal loadings and location are: as shown in FIG. 1, both washcoats have the same composition (two coatings to attain the desired loading) 10 g/ft³ of palladium, 35 g/ft³ of platinum, and 5 g/ft³ of rhodium, in both undercoat and overcoat. Therefore, the total precious metal loading on the finished catalyst is: 20 g/ft³ of palladium, 70 g/ft³ of platinum, and 10 g/ft³ of rhodium. Alternatively, as shown in FIG. 2, platinum and palladium are uniform in undercoat and platinum and rhodium are uniform in the overcoat. The precious metal loading can be 10 g/ft³ of palladium and 35 g/ft³ of platinum in undercoat, with 10 g/ft³ of palladium, 35 g/ft³ of platinum, and 10 g/ft³ of rhodium in the overcoat. In yet another alternative, 10 g/ft³ of palladium and 35 g/ft³ of platinum can be in both undercoat and overcoat, with 10 g/ft³ of rhodium on surface of overlayer. The total precious metal loading on finished catalyst is: 20 g/ft³ of palladium, 70 g/ft³ of platinum, and 10 g/ft³ of rhodium.

The catalysts, after the above coatings are applied, are impregnated with the barium and potassium acetate solutions, followed by drying and calcinations, for example. The preferred barium loading is about 700 g/ft³ to about 750 g/ft³, with about 726 g/ft³ especially preferred. The preferred potassium loading is 250 g/ft³ to about 300 g/ft³, with about 276 g/ft³ especially preferred. The finished catalysts preferably have barium and potassium uniformly distributed in both the undercoat and the overcoat. Since, in all three configurations, platinum is distributed uniformly in both washcoat layers, the configurations allow maximal proximity of platinum and trapping materials (e.g., barium (Ba) and potassium (K)). Therefore, the catalysts have maximized NOx storage capacity.

Disposition of the catalyst on the substrate can be accomplished in various manners. For example, the substrate can be dipped in a slurry comprising the trapping materials and catalyst materials except the Rh. The substrate can then be dipped in a second slurry comprising the overlayer composition, minus the Rh. Once the underlayer and overlayer are applied, the outer portion can be applied by impregnating the Rh into the overlayer. Finally, optional additional trapping materials can be applied over the outer portion by dipping the coated substrate in a solution of the trapping materials (e.g., metals in an acetate or similar solution). The coated substrate is then fired. During each application step, multiple dippings, impregnations, or other applications can be employed to attain the desired loadings.

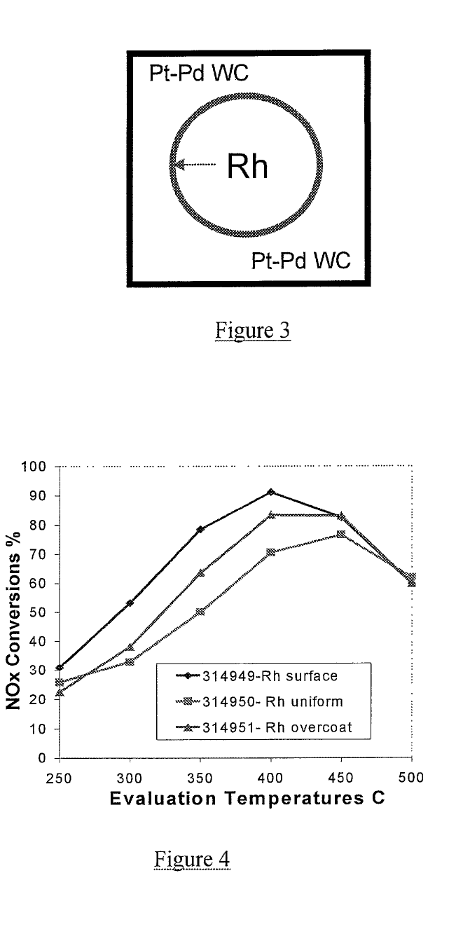

The location of the Rh catalyst allows for the maximization of the NO_{X} conversions and the minimization of the NO_{X} leakage (e.g., discharged to the environment in the exhaust gas) during regeneration. Two configurations of the catalyst configuration are depicted in FIG. 1, FIG. 2 and FIG. 3. FIG. 1 shows the Rh is uniform in both undercoat and overcoat. In this configuration the negative interaction of Pd and Rh is present. FIG. 2 depicts a catalyst configuration wherein Rh is uniformly distributed throughout overlayer, wherein the weight percent of Rh catalyst in the overlayer is greater than or equal to 75% of the weight of Rh catalyst in the catalyst configuration. The Rh catalyst is located predominately in the overlayer to maximize the Rh catalyst contact with pollutants passing over the overlayer as well as with the NO that travels through the overlayer when released from the trapping materials. In this configuration, the Pt—Pd is present only in the undercoat and Pt—Rh is present only in the overcoat, therefore negative interaction of Pd and Rh is eliminated.

FIG. 3 depicts a catalyst configuration wherein the weight percent of Rh catalyst located in the outer portion is greater than or equal to 75% of the weight percent of Rh catalyst in the catalyst configuration. Since there is an amount of Rh in the outer layer, the pollutants passing over the overlayer will be exposed to a much higher concentration of Rh catalyst. The released NO from the underlayer will pass through the outer layer and therefore be exposed to a higher concentration of Rh catalyst. Therefore, the conversion efficiency will be increased. In this configuration, NO_{X} adsorbers convert several times the amount of NO_{X} during regeneration as compared to a typical 3-way catalyst. Table-I summarizes the relative NO_{X} parts per million (ppm) for a 3-way catalyst system at stoichiometric operation and for a NO_{X} adsorber during regeneration. The data in Table 1 highlights the significance of Rh functioning for maximized NO_{X} conversion, particularly during rich regeneration, to prevent NO_{X} leakage.

TABLE 1

| Catalyst Type | Engine operation | NOₓ ppm | |
|---|---|---|---|
| 3-way catalyst | Continuous stoichiometric | 1,500 | ppm |
| NOₓ adsorber catalyst | 30 sec lean (A/F = 17-35) | Lean: 500 | ppm |
| | 2 sec rich (A/F = 11-14) | Rich: 7,500 | ppm |

“sec” means seconds
A/F means air to fuel ratio
stoichiometric means an A/F around 14.7

In a 3-way catalyst system, the exhaust gas reaching the catalyst is essentially balanced with reductants (HC and CO) and oxidants (NO and O₂). When these gaseous components contact the catalyst, they are converted to CO₂, H₂O, and N₂ spontaneously. In a NO_{X} adsorber, however, NO_{X} is stored during engine lean operation. Therefore, oxidants are already present in the adsorber. During the engine rich operation, the exhaust gas that reaches the adsorber is rich (e.g., an A/F of less than about 14). The predominant reductant produced by the engine during the rich operation is CO. Rh is effective for the CO/NO_{X} conversion reaction. The rich exhaust reacts with released NO_{X} in the presence of Rh to form CO₂, H₂O and N₂. The catalyst configuration allows for the maximization of NO_{X} conversions and for the minimization of NO_{X} leakage during regeneration.

The catalyst configuration may be used to reduce exhaust emissions of gasoline direct injection engine or diesel engines. Lean exhaust emissions, generated by the engine operating under lean conditions, are contacted with the catalyst configuration. The lean exhaust contains NO which is converted to NO₂ in the presence of a catalyst. The NO₂ is adsorbed through reaction with the trapping material(s). Periodically, or when the absorber becomes loaded with NO₂ (e.g., as is evidenced by an increase in nitrogen oxides down stream from the adsorber or at the adsorber outlet), the engine operation switches to rich conditions. Under rich conditions, the trapping materials release the NO₂. The Rh catalyst converts the released NO₂ to N₂.

### EXAMPLE

A comparison of catalyst configurations was conducted. A sample catalyst configuration with Rh catalyst uniformly distributed throughout the overlayer was compared with sample catalyst composition configurations with Rh catalyst located predominately in the outer portion.

The catalyst was aged for 50 hours on a 4.8 liter (L) engine dynamometer running at stoichiometry with periodic fuel cut (i.e., ceasing of the fuel flow). The catalyst bed temperature was 800° C. during the aging. The catalysts were then evaluated on a 5.0L dynamometer for performance. The tests comprised: 1) lean/rich modulation: 30 sec at A/F of 21.5 and 2 sec at A/F of 12.5 at 250° C., 300° C., 350° C., 400° C., 450, and 500° C. catalyst inlet temperatures with an exhaust flow space velocity of 50,000/hr 2) stoichiometric light off tests with the temperature rising from 200° C. to 500° C. with a 50° C. per minute temperature ramp rate; and 3) stoichiometric conversion test at 400° C.

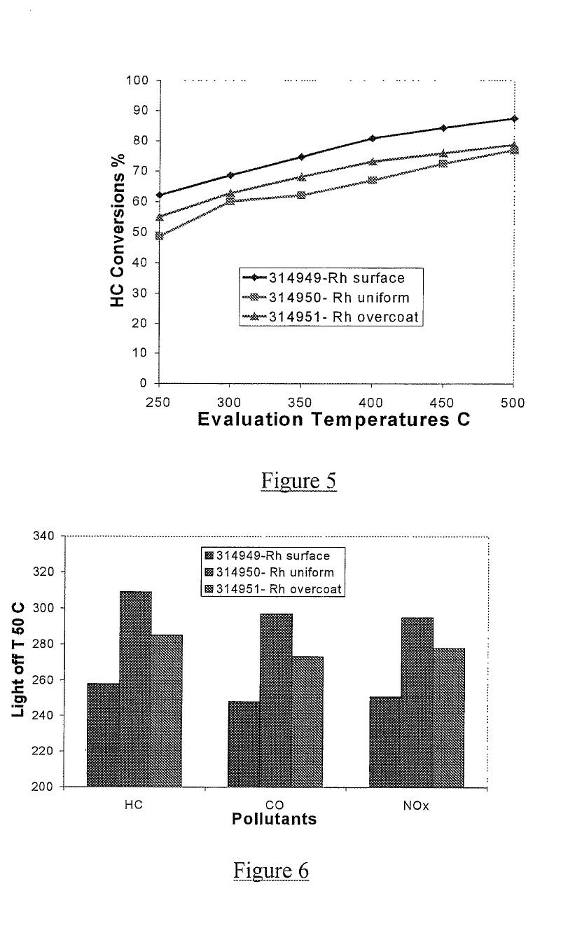

FIG. 4 shows NO_{X} conversions over temperatures under lean/rich modulations after aging. Aging generally refers to the deterioration of the catalyst by age. Specifically, aging impacts catalyst performance and degradation. FIG. 5 shows hydrocarbon (HC) conversions over temperatures under lean/rich modulations after aging. Both FIGS. 4 and 5 show that having Rh catalyst located predominately in the outer layer has superior NO_{X} and HC conversions as compared to the configuration wherein Rh catalyst is uniformly distributed throughout both washcoat or the overlayer.

FIG. 6 shows stoichiometric light off temperature after aging of the catalyst. The term ‘light off temperature’ designates the exhaust gas temperature at which 50% of the respective pollutant is converted by the catalyst. The light off temperature is different for HC, CO, and NO_{X}. The data shows that catalyst with Rh on surface of the overlayer has lower light off temperature than Rh uniformly distributed in both washcoat layers or Rh in overlayer.

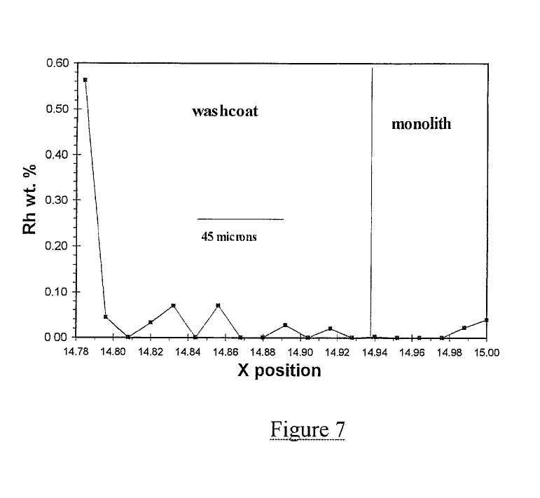

FIG. 7 is microprobe data showing that the Rh-containing outer portion is 10 micrometers thick. The data indicate that the weight percent of Rh catalyst changes as a function of distance from surface of washcoat going deeper into washcoat all the way to substrate.

The catalyst configuration allows for the maximization of conversion efficiency, namely (a) NO_{X} storage efficiency and capacity, (b) effective NO_{X} release under rich operating conditions, and (c) effective NO_{X} conversions. Thereby, NO_{X} conversion efficiency is maximized and NO_{X} leakage during regeneration is minimized. A NO_{X} adsorber with maximized conversion efficiency will result in effective NOx emission control.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A catalyst configuration, comprising:
a substrate;
an underlayer disposed on the substrate, the underlayer comprising a first catalyst composition; and
an overlayer disposed on a side of the underlayer opposite the substrate, wherein the overlayer comprises a second catalyst composition comprising greater than or equal to about 75% of Rh in the catalyst configuration.

2. The catalyst configuration of claim 1, further comprising a trapping material.

3. The catalyst configuration of claim 2, wherein the trapping material is selected from the group consisting of rare earths, alkaline earths, and alkali oxides, carbonates, alloys, and combinations comprising at least one of the foregoing trapping materials.

4. The catalyst configuration of claim 1, wherein the underlayer and the overlayer comprise a metal selected from the group consisting of platinum, palladium, and alloys and combinations comprising at least one of the foregoing metals.

5. The catalyst configuration of claim 1, wherein the overlayer comprises an outer portion disposed on a side opposite the underlayer, and wherein greater than or equal to about 75% of the Rh in the catalyst configuration is disposed in the outer portion.

6. The catalyst configuration of claim 5, wherein the outer portion has a thickness of about 1 to about 30 micrometers.

7. The catalyst configuration of claim 6, wherein the thickness is about 5 to about 15 micrometers.

8. The catalyst configuration of claim 7, wherein the thickness is about 7 to about 12 micrometers.

9. The catalyst configuration of claim 1, wherein the Rh is present in an amount of about 2 g/ft³ to about 30 g/ft³.

10. The catalyst configuration of claim 9, wherein the Rh is present in an amount of about 5 g/ft³ to about 20 g/ft³.

11. The catalyst configuration of claim 10, wherein the Rh is present in an amount of about 7 g/ft³ to about 15 g/ft³.

12. The catalyst configuration of claim 1, wherein a combined loading of the first catalyst composition and the second catalyst composition on the substrate is about 1 μm³ to about 10 g/in³.

13. The catalyst configuration of claim 12, wherein the combined loading is about 2 g/in³ to about 7 g/in³.

14. The catalyst configuration of claim 13, wherein the combined loading is about 3 g/in³ to about 5 g/in³.

15. A NOx adsorber comprising:
a housing concentrically disposed around a catalyst configuration comprising a substrate, an underlayer disposed on the substrate, the underlayer comprising a first catalyst composition, and an overlayer disposed on a side of the underlayer opposite the substrate, wherein the overlayer comprises a second catalyst composition comprising greater than or equal to about 75% of Rh in the catalyst configuration.

16. A method for reducing emissions, comprising:
contacting a gas stream with catalyst configuration comprising a substrate, an underlayer disposed on the substrate, the underlayer comprising a first catalyst composition, and an overlayer disposed on a side of the underlayer opposite the substrate, wherein the overlayer comprises a second catalyst composition comprising greater than or equal to about 75% of Rh in the catalyst configuration;
oxidizing NO in the gas to NO₂;
adsorbing the NO₂;
increasing a hydrocarbon concentration in the gas;
converting the NO₂ to N₂; and
releasing the N₂.
